(19) United States
(12) Patent Application Publication
(10) Pub. No.: US 2004/0100712 A1
(43) Pub. Date: May 27, 2004

(54) Handling data fault and retry in writing/reading data to/from a disk

(75) Inventor: David M. Drouin, Milpitas, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA

(21) Appl. No.: 10/687,462

(22) Filed: Oct. 16, 2003

Related U.S. Application Data
(60) Provisional application No. 60/429,794, filed on Nov. 27, 2002.

(51) Int. Cl. G11B 5/02

(52) U.S. Cl. 360/55

(57) ABSTRACT

One embodiment of the present invention is a method for writing data on a number of sectors of a track of a disk drive that includes: (a) sending a signal to write data on a first sector of the track; (b) receiving a write data default; (c) sending a signal to write data on another sector of the track after skipping a predetermined number of sectors; (d) waiting for the first sector to be in position again; and (e) sending a signal to retry to write data on the first sector if a predetermined number of retries to write data on the track has not been exceeded.

This application claims the benefit of U.S. Provisional Application No. 60/429,794, filed on Nov. 27, 2002, which is incorporated herein by reference.

### TECHNICAL FIELD OF THE INVENTION

One or more embodiments of the present invention relate generally to methods for handling write/read data fault and retry in writing/reading data to/from a disk.

### BACKGROUND OF THE INVENTION

In accordance with prior art methods for handling write/read data default and retry in writing/reading data to/from a disk, a write operation requiring that data be written in, for example, one hundred (100) consecutive sectors (0 through 99) would typically proceed as follows. Once sector 0 of a disk track is reached, a data handler servo controller would cause data writing to start in accordance with any one of a number of methods that are well known to those of ordinary skill in the art. If a write data fault was detected in accordance with any one of a number of methods that are well known to those of ordinary skill in the art (such a write data fault may be due to any one of a number of events such as, for example and without limitation: (a) external shock or vibration that cause heads to be moved off track center, (b) detection of improper servo sector data, and (c) so forth), the data handler servo controller would cause writing to cease immediately in accordance with any one of a number of methods that are well known to those of ordinary skill in the art to prevent data from being written incorrectly and/or possibly affecting data already recorded in adjacent data tracks. At the time the write data default was detected, a certain number of data sectors may already have been written, and a certain number may remain to be written. In such a case, and in accordance with such prior art methods, as the disk continues to rotate, the data handler servo controller would cause data writing to start again (this is referred to as a retry) once the sector at which the write data fault was detected is again in position for writing. This process would be repeated as write data faults occur. Finally, in accordance with such prior art methods, either the entire 100 sectors has been written successfully, or a predetermined number of retries has been performed. A similar procedure is used for reading data.

As one can readily appreciate from the above, the above-described prior art methods are inefficient and consume much time.

In light of the above, there is a need to overcome one or more of the above-identified problems.

### SUMMARY OF THE INVENTION

One or more embodiments of the present invention satisfy one or more of the above-identified needs in the art. In particular, one embodiment of the present invention is a method for writing data on a number of sectors of a track of a disk drive that comprises: (a) sending a signal to write data on a first sector of the track; (b) receiving a write data default; (c) sending a signal to write data on another sector of the track after skipping a predetermined number of sectors; (d) waiting for the first sector to be in position again; and (e) sending a signal to retry to write data on the first sector if a predetermined number of retries to write data on the track has not been exceeded.

### BRIEF DESCRIPTION OF THE DRAWING

FIG. 1 shows a flowchart of one or more embodiments of the present invention for writing data;

FIG. 2 shows a flowchart of one or more embodiments of the present invention for reading data;

FIG. 3 shows one set of simulated retry sequences required to write data for one hundred (100) sectors where six random data sectors in a track for each disk revolution are indicated as providing data faults: (a) using prior art methods described in the Background of the Invention, and (b) using an embodiment of the present invention; and

FIG. 4 shows another set of simulated retry sequences required to write data for one hundred (100) sectors where six random data sectors in a track for each revolution are indicated as providing data faults: (a) using prior art methods described in the Background of the Invention, and (b) using an embodiment of the present invention.

### DETAILED DESCRIPTION

In accordance with one or more embodiments of the present invention, a write operation requiring that data be written in, for example, one hundred (100) consecutive sectors (0 through 99) of a disk track proceeds as follows. Once sector 0 of a disk track on a disk of a disk drive is reached in accordance with any one of a number of methods that are well known to those of ordinary skill in the art, a data handler servo controller in the disk drive causes data writing to start in accordance with any one of a number of methods that are well known to those of ordinary skill in the art. If a write data fault is detected in accordance with any one of a number of methods that are well known to those of ordinary skill in the art (for example, as the data is being written or after it is written), the data handler servo controller causes writing to stop in accordance with any one of a number of methods that are well known to those of ordinary skill in the art, however, only for the sector at which the write data fault was detected. Then, in accordance with one or more embodiments of the present invention, the data handler servo controller causes writing to start after skipping a predetermined number of sectors after the sector at which the write data default was detected. For example, the predetermined number can be zero, in which case writing will start at the immediate next sector. In addition, the predetermined number can be 1, 2, or more. Next, as the disk continues to rotate, and in accordance with such one or more embodiments of the present invention, the data handler servo controller causes writing to start at those sectors that were not written on previous revolutions due to detection of write data faults (this is a retry). This is repeated until all 100 sectors are successfully written, or until a predetermined number of retries has been performed. In accordance with one or more of such embodiments, in accordance with any one of a number of methods that are well known to those of ordinary skill in the art, the data handler servo controller notes sectors that have already been written, and notes sectors that were not written due to occurrences of write data defaults.

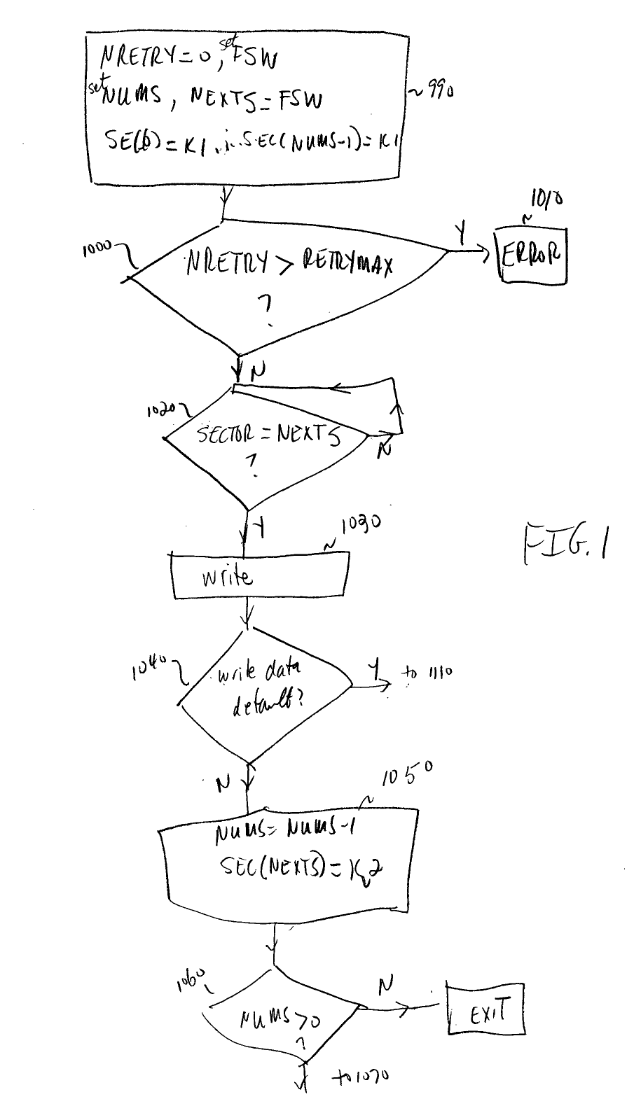

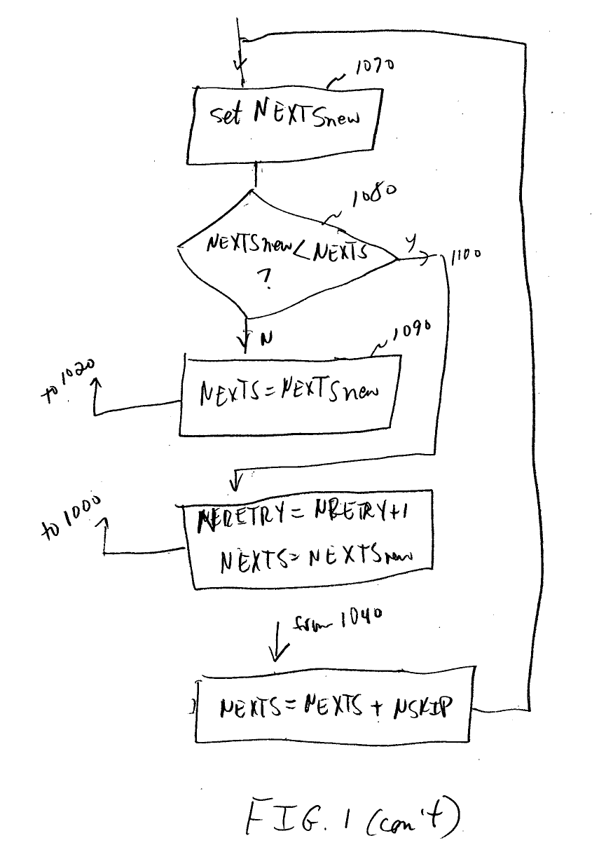

FIG. 1 shows a flowchart of one or more embodiments of the present invention for writing data. As shown at box 990, the data handler servo controller sets: (a) the “number of retries” (NRETRY) equal to 0, (b) the “first sector of data to be written in a track” (FSW), (c) the “number of sectors to be written in the track” (NUMS), (d) “next sector to write” (NEXTS) equal to FSW, and (e) SEC(0) through SEC(NUMS−1)=K1 (where a value of K1 indicates that a sector has not been written and a value of K2 means that the sector has been written). Control is then transferred to decision box 1000.

At decision box 1000, determine whether the “number of retries” (NRETRY) exceeds a predetermined maximum (RETRYMAX). If so, control is transferred to box 1010 to report a write error, otherwise, control is transferred to decision box 1020.

At decision box 1020, determine whether the “next sector to write” (NEXTS) has been reached. If so, control is transferred to box 1030, otherwise, wait.

At box 1030, send a command to write a sector, i.e., NEXTS. Control is then transferred to decision box 1040.

At decision box 1040, determine whether a write data default occurred. If so, control is transferred to box 1110, otherwise, control is transferred to 1050.

At box 1050, decrement the number of sectors to be written (NUMS=NUMS−1) and set SEC(NEXTS)=K2. Control is then transferred to decision box 1060.

At decision box 1060, determine whether more data is to be written (NUMS>0?). If so, control is transferred to box 1070, otherwise exit.

At box 1070, set NEXTSnew by searching for the next entry in SEC( ) after NEXTS that equals K1 (wrapping around SEC( )). Control is then transferred to decision box 1080.

At decision box 1080, determine whether another disk revolution is required to write more of the data, i.e., whether NEXTSnew<NEXTS. If so, control is transferred to box 1100, otherwise control is transferred to box 1090.

At box 1090, reset NEXTS (i.e., NEXTS=NEXTSnew). Control is then transferred to decision box 1020.

At box 1100, increment the number of retries by 1 (NRETRY=NRETRY+1) and reset NEXTS (i.e., NEXTS=NEXTSnew). Control is then transferred to decision box 1000.

At box 1110, increment NEXTS by a predetermined number (NSKIP). Control is then transferred to box 1070.

It should be readily appreciated by those of ordinary skill in the art that one or more further embodiments of the present invention may be utilized for reading data from a disk. For the case of reading data, the data handler servo controller causes data from all of the sectors requested to be read into a data buffer. As the data is read, read data defaults are detected so the data handler servo controller may determine which sectors have been read in error. Then, in accordance with one or more such embodiments of the present invention, on subsequent revolutions of the disk, the data handler servo controller causes all sectors having read data faults to be read again (this is a retry). This is repeated until all data sectors are successfully read, or until a predetermined number of retries has been performed. In accordance with one or more of such embodiments, in accordance with any one of a number of methods that are well known to those of ordinary skill in the art, the data handler servo controller notes sectors that have been read without fault, and notes sectors for which read data defaults have occurred.

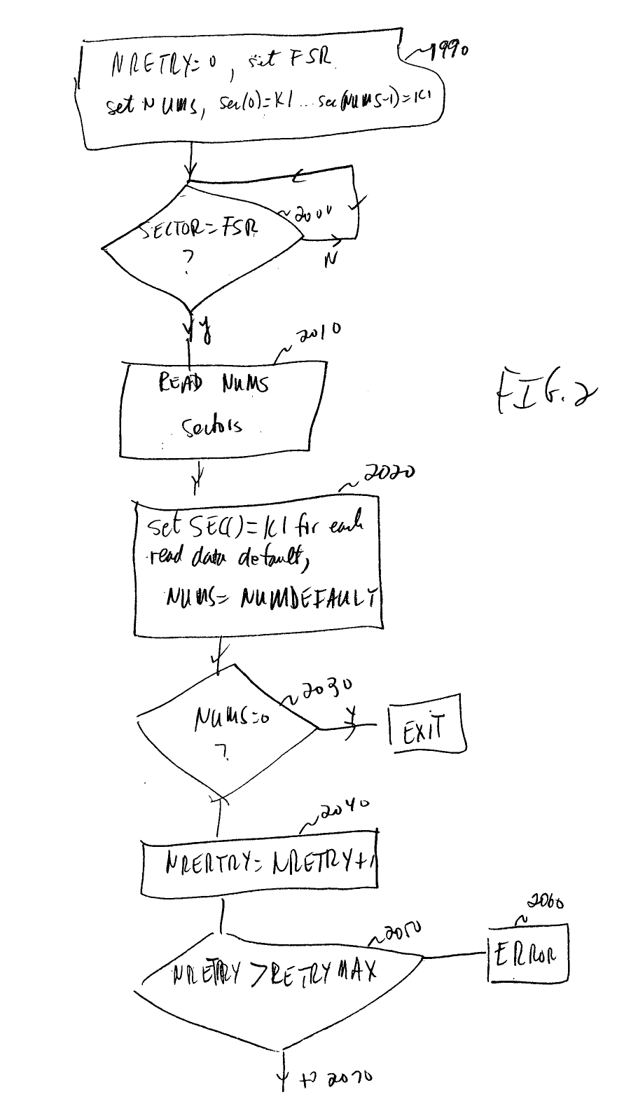

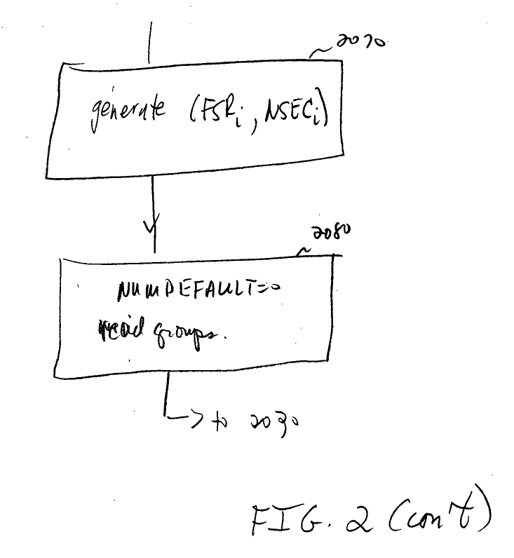

FIG. 2 shows a flowchart of one or more embodiments of the present invention for reading data. As shown at box 1990, the data handler servo controller sets: (a) the “number of retries” (NRETRY) equal to 0, (b) the “first sector of data to be read in a track” (FSR), (c) the “number of sectors to be read in the track” (NUMS), and (d) SEC(0) through SEC(NUMS−1)=K2 (where K1 indicates that the sector has yet to be read and K2 means that the sector has been read). Control is then transferred to box decision 2000.

At decision box 2000, determine whether the “first sector to be read” (FSR) has been reached. If so, control is transferred to box 2010, otherwise wait.

At box 2010, send a command to read NUMS sectors. Control is then transferred to box 2020.

At box 2020, receive read data fault signals, set SEC( )=K1 for each sector for which a read data default was received, set NUMDEFAULT equal to the number of defaults received, set NUMS=NUMDEFAULT. Control is then transferred to decision box 2030.

At decision box 2030, determine whether NUMS=0. If so, exit, otherwise, control is transferred to box 2040.

At box 2040, increment the number of retries by 1 (NRETRY=NRETRY+1). Control is then transferred to decision box 2050.

At decision box 2050, determine whether the “number of retries” (NRETRY) exceeds a predetermined maximum (RETRYMAX). If so, control is transferred to box 2060 to report a read error, otherwise, control is transferred to box 2070.

At box 2070, determine groups of pairs of values (FSRI, NSECI) that represent (first sector to be read in a group, number of consecutive sectors for which read data defaults were received) by searching SEC( ) for instances of K1, where the number of such groups is NUMGroup. Set SEC( ) from K1 back to K2. Control is then transferred to box 2080.

At box 2080, set NUMDEFAULT=0, and loop over the groups for the remainder of the disk revolution. Do the following for each group. Determine whether FSRᵢ has been reached. If so, send a command to read NSECᵢ sectors, otherwise wait. Receive any read data fault signals, and set SEC( )=K1 for each sector for which a read data default was received, and increment NUMDEFAULT. Finally, set NUMS=NUMDEFAUL. Control is then transferred to decision 2030.

It should be appreciated that in carrying out one or more embodiments described above, there are some types of write/read data defaults that are of a type that require the data handler servo controller to wait for a predetermined number of sectors to pass (for example up to an entire revolution of the disk) before trying to write/read again.

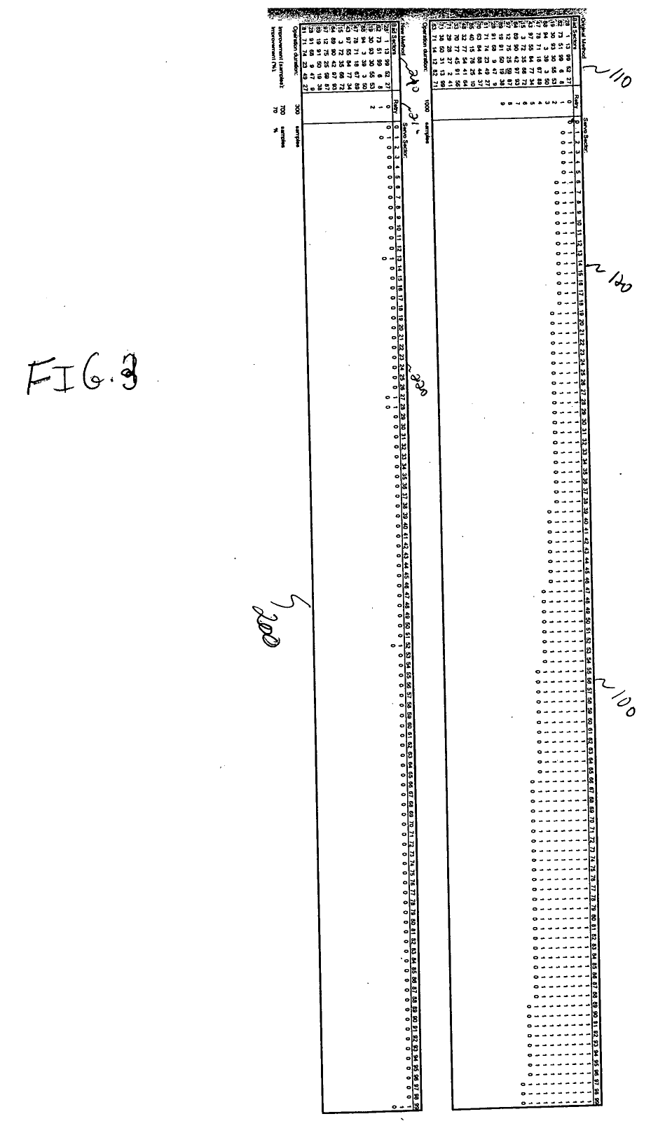

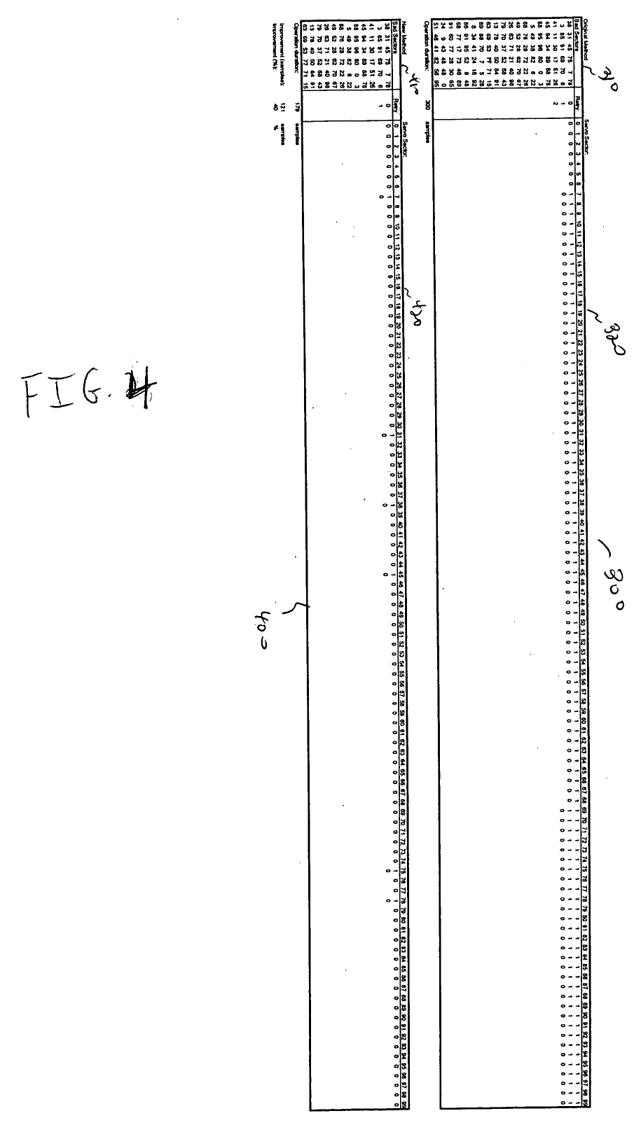

FIGS. 3 and 4 show simulated sequences required to write data for one hundred (100) sectors where six random data sectors in a track for each disk revolution are indicated as providing write data faults. The data shown in FIGS. 3 and 4 are believed to be typical of a disk drive that is exposed to certain types of vibration, or one that exhibits other data faults such as, for example and without limitation, non-repeatable run-out (“NRRO”). FIG. 3 shows one set of simulated retry sequences required to write data for one hundred (100) sectors where six random data sectors in a track for each revolution are indicated as providing data faults. Section 100 of FIG. 3 corresponds to results achieved using prior art methods described in the Background of the Invention, and section 200 of FIG. 3 corresponds to results achieved using an embodiment of the present invention. As shown in section 100 of FIG. 3, on the first line of section 110 (corresponding to one revolution of the disk drive), sectors 1, 27, 28, 13, 99, and 52 produce write data faults. Next, as shown on the first line of section 120 (where 0 means that a sector was written, and 1 means a sector was not written), in the first disk revolution, only sector 1 was written. Next, on the second line of section 110 (corresponding to one revolution of the disk drive), sectors 6, 8, 51, 62, 73 and 99 produce write data faults. Next, as shown on the second line of section 120, in the second disk revolution, sectors 1-5 were written. Continuing in this manner, one can readily appreciate that section 100 of FIG. 3 shows that ten (10) disk revolutions were required to write the 100 sectors of information using the prior art methods.

As shown in section 200 of FIG. 3, on the first line of section 210, sectors 1, 27, 28, 13, 99, and 52 produce write data faults. Next, as shown on the first line of section 220, in the first disk revolution, sectors 0, 2-12,14-26, 29-51, and 53-98 were written. Next, on the second line of section 210, sectors 6, 8, 51, 62, 73 and 99 produce write data faults. Next, as shown on the second line of section 220, in the second disk revolution, sectors 1, 13, 27-28, and 52 were written. Continuing in this manner, one can readily appreciate that section 200 of FIG. 3 shows that three (3) disk revolutions were required to write the 100 sectors of information using an embodiment of the present invention.

FIG. 4 shows another set of simulated retry sequences required to write data for one hundred (100) sectors where six random data sectors in a track for each revolution are indicated as providing data faults. Section 300 of FIG. 4 corresponds to results achieved using a prior art method described in the Background of the Invention, and section 400 of FIG. 4 corresponds to results achieved using an embodiment of the present invention. As one can readily appreciate from FIG. 4, three (3) disk revolutions were required to write the 100 sectors of information using the prior art method, whereas two (2) disk revolutions were required to write the 100 sectors of information using an embodiment of the present invention.

Although various embodiments that incorporate the teachings of the present invention have been shown and described in detail herein, those skilled in the art can readily devise many other varied embodiments that still incorporate these teachings.

What is claimed is:

1. A method for writing data on a number of sectors of a track of a disk drive that comprises:
sending a signal to write data on a first sector of the track;
receiving a write data default;
sending a signal to write data on another sector of the track after skipping a predetermined number of sectors;
waiting for the first sector to be in position again; and
sending a signal to retry to write data on the first sector if a predetermined number of retries to write data on the track has not been exceeded.

2. A method of reading data from a number of sectors of a track of a disk drive that comprises:
sending a signal to read data from the number of sectors starting at a first sector of the track;
receiving one or more read data defaults;
waiting for the first sector to be in position again; and
sending a signal to retry to read data from sectors of the track that were unable to be read previously if a predetermined number of retries to read data has not been exceeded.

3. The method of claim 1 wherein the predetermined number of sectors to skip is 0.

4. The method of claim 1 wherein the predetermined number of sectors to skip is 1, 2 or more.
